(19) United States
(12) Patent Application Publication
(10) Pub. No.: US 2023/0376617 A1
(43) Pub. Date: Nov. 23, 2023

(54) INFORMATION PROCESSING APPARATUS, NON-TRANSITORY COMPUTER READABLE MEDIUM STORING PROGRAM, AND INFORMATION PROCESSING METHOD

(71) Applicant: FUJIFILM Business Innovation Corp., Tokyo (JP)

(72) Inventor: Yasuhiro MARUYAMA, Kanagawa (JP)

(73) Assignee: FUJIFILM Business Innovation Corp., Tokyo (JP)

(21) Appl. No.: 17/967,881

(22) Filed: Oct. 17, 2022

(30) Foreign Application Priority Data
May 18, 2022 (JP) 2022-081694

(51) Int. Cl. G06F 21/62

(52) U.S. Cl. CPC G06F 21/62

(57) ABSTRACT

An information processing apparatus includes a processor configured to receive access to a first domain from a user terminal, and before the user terminal transitions to another cooperating domain from the first domain, display a screen for receiving consent to use of a cookie requested in accordance with the access to the first domain and consent to use of a cookie requested in accordance with the access to the other domain cooperating with the first domain on the user terminal.

### CROSS-REFERENCE TO RELATED APPLICATIONS

This application is based on and claims priority under 35 USC 119 from Japanese Patent Application No. 2022-081694 filed May 18, 2022.

### BACKGROUND

### (i) Technical Field

The present disclosure relates to an information processing apparatus, a non-transitory computer readable medium storing a program, and an information processing method.

### (ii) Related Art

JP2014-232359A discloses an information processing server system that checks consent of a user to terms of use using a second authentication section different from a first authentication section used for using a web service by a client.

JP6800054B discloses an information management apparatus that reduces a load of a user in a case where the user checks a privacy policy in which a service provider requests consent from the user.

JP6719875B discloses an authentication server that can prevent acquisition of cookie information by an unnecessary service.

### SUMMARY

In a service provided on the Internet, a system referred to as a cookie for storing information issued by the service in a browser is used. In a case where the service uses the cookie, consent to the use of the cookie needs to be acquired from a user for each domain in which the service is provided.

For example, in receiving provision of a service from a first domain and another domain that is a domain cooperating with the first domain and to which a transition is made from the first domain, first, the consent to the use of the cookie requested in accordance with access to the first domain needs to be acquired from the user in a case where the user has accessed the first domain. Furthermore, after the user has transitioned to the other domain from the first domain, the consent to the use of the cookie requested in accordance with access to the other domain needs to be acquired again from the user.

Aspects of non-limiting embodiments of the present disclosure relate to an information processing apparatus, a non-transitory computer readable medium storing a program, and an information processing method that, in a case where a user receives provision of a service from a plurality of cooperating domains, eliminates need for acquiring consent to use of a cookie from the user each time the user accesses each domain.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided an information processing apparatus including a processor configured to receive access to a first domain from a user terminal, and before the user terminal transitions to another cooperating domain from the first domain, display a screen for receiving consent to use of a cookie requested in accordance with the access to the first domain and consent to use of a cookie requested in accordance with the access to the other domain cooperating with the first domain on the user terminal.

### BRIEF DESCRIPTION OF THE DRAWINGS

Exemplary embodiment(s) of the present invention will be described in detail based on the following figures, wherein:

FIG. 1 is a diagram illustrating a system configuration of an information processing system of an exemplary embodiment of the present disclosure;

FIG. 2 is a block diagram illustrating a hardware configuration of an authentication server;

FIG. 3 is a block diagram illustrating a functional configuration of the authentication server;

FIG. 4 is a block diagram illustrating a hardware configuration of the service provision server;

FIG. 5 is a block diagram illustrating a hardware configuration of a cookie information management server;

FIG. 6 is a block diagram illustrating a hardware configuration of a personal computer;

FIG. 7 is a diagram for describing a summary of a cooperating service in the information processing system;

FIG. 8 is a diagram illustrating an example of a client management table managed in a cookie consent management server;

FIG. 9 is a diagram illustrating an example of a cookie consent information management table managed in the cookie consent management server;

FIG. 10 is a display example of a screen of a website of service 1;

FIG. 11 is a display example of a screen of a website for login and is a diagram illustrating a state where an operation of a service provision unit is prohibited;

FIG. 12 is a diagram illustrating a display example of a screen of detailed cookie setting;

FIG. 13 is a diagram illustrating another display example of the screen of the detailed cookie setting;

FIG. 14 is a display example of the screen of the website for login and is a diagram illustrating a state where the operation of the service provision unit is permitted;

FIG. 15 is a diagram illustrating an example of a table;

FIG. 16 is a diagram illustrating another display example of the screen of the website for login;

FIG. 17 is a diagram illustrating still another display example of the screen of the website for login;

FIG. 18 is a first half of a flowchart illustrating a flow of process of acquiring consent to use of a cookie of each domain from a user in the information processing system; and

FIG. 19 is a second half of the flowchart illustrating the flow of process of acquiring the consent to the use of the cookie of each domain from the user in the information processing system.

### DETAILED DESCRIPTION

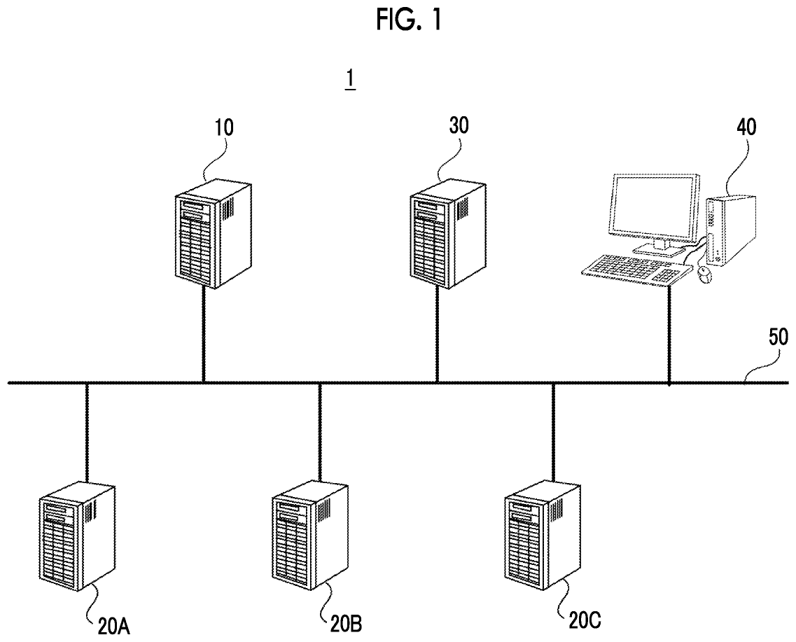

Hereinafter, exemplary embodiments of the present invention will be described in detail with reference to the drawings. FIG. 1 is a diagram illustrating a system configuration of an information processing system 1 of a first exemplary embodiment.

As illustrated in FIG. 1, the information processing system 1 of the present exemplary embodiment is configured with an authentication server 10, a plurality of service provision servers 20A to 20C, a cookie consent management server 30, and a personal computer 40 that are connected to each other via an Internet 50.

The information processing system 1 is a system that can provide a service using a cookie in cooperation among a plurality of domains on the Internet to the personal computer 40 that is a user terminal. A cookie means a system for storing information related to a user who has accessed a website provided by a domain in a user terminal and utilizing the information stored in the user terminal on the website.

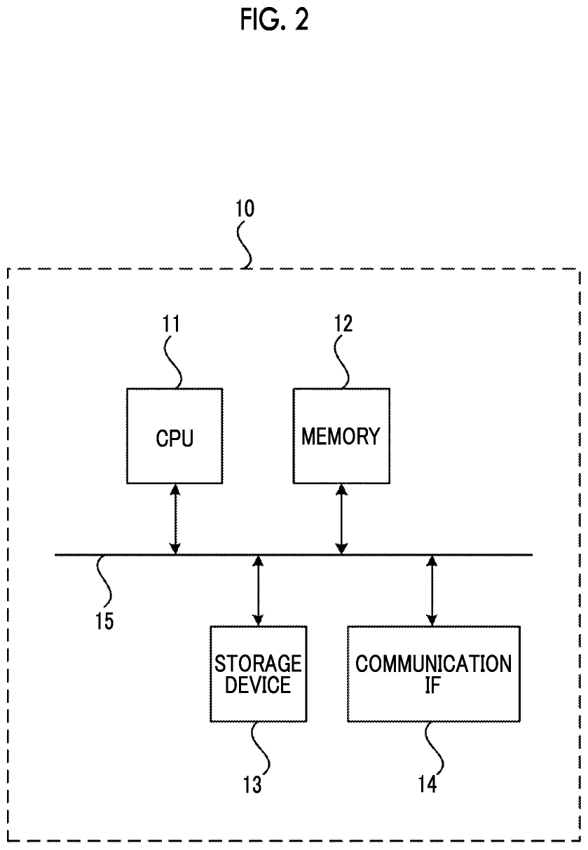

The authentication server 10 is an example of an information processing apparatus according to an exemplary embodiment of the present disclosure and is an example of a server that provides a service in a first domain. FIG. 2 is a block diagram illustrating a hardware configuration of the authentication server 10.

As illustrated in FIG. 2, the authentication server 10 includes a central processing unit (CPU) 11, a memory 12, a storage device 13 such as a hard disk drive, a communication interface (hereinafter, abbreviated to IF) 14 that transmits and receives data to and from an external apparatus or the like, and a control bus 15.

The CPU 11, the memory 12, the storage device 13, and the communication IF 14 are connected to each other via the control bus 15.

The CPU 11 is a processor that controls an operation of the authentication server 10 by executing a predetermined process based on a control program stored in the memory 12 or the storage device 13. In the present exemplary embodiment, while the CPU 11 is described as reading and executing the control program stored in the memory 12 or the storage device 13, the present disclosure is not limited thereto. The control program may be provided in the form of a recording on a computer readable recording medium. For example, the program may be provided in the form of a recording on an optical disc such as a compact disc (CD)-read only memory (ROM) and a digital versatile disc (DVD)-ROM or in the form of a recording on a semiconductor memory such as a universal serial bus (USB) memory and a memory card. In addition, the control program may be acquired from the external apparatus via a communication line connected to the communication IF 14.

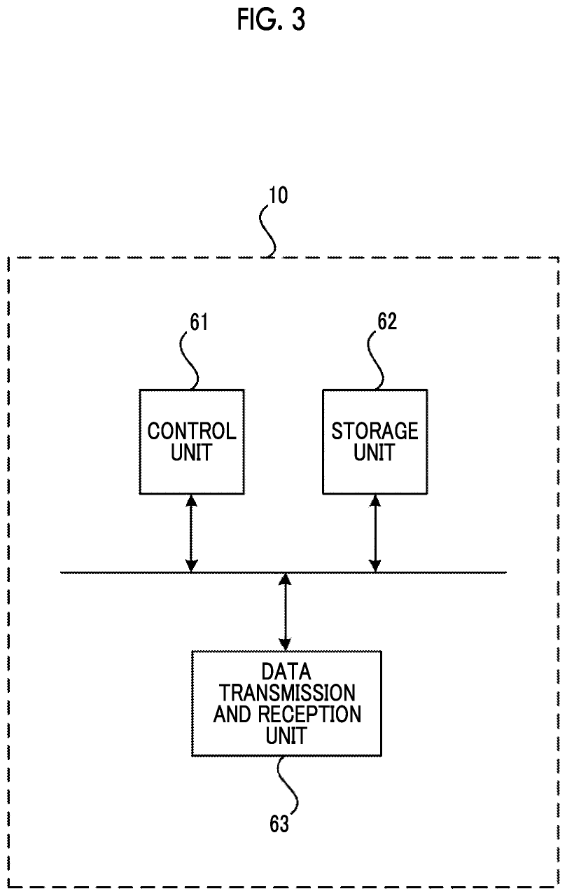

FIG. 3 is a block diagram illustrating a functional configuration of the authentication server 10 implemented by executing the control program. As illustrated in FIG. 3, the authentication server 10 of the present exemplary embodiment includes a control unit 61, a storage unit 62, and a data transmission and reception unit 63.

The control unit 61 performs a control process of an overall operation of the authentication server 10, an authentication process of a user using the authentication server 10 and the service provision servers 20A to 20C, and the like. The storage unit 62 stores the control program and also information necessary for the operation of the authentication server 10. The data transmission and reception unit 63 transmits and receives data to and from the external apparatus.

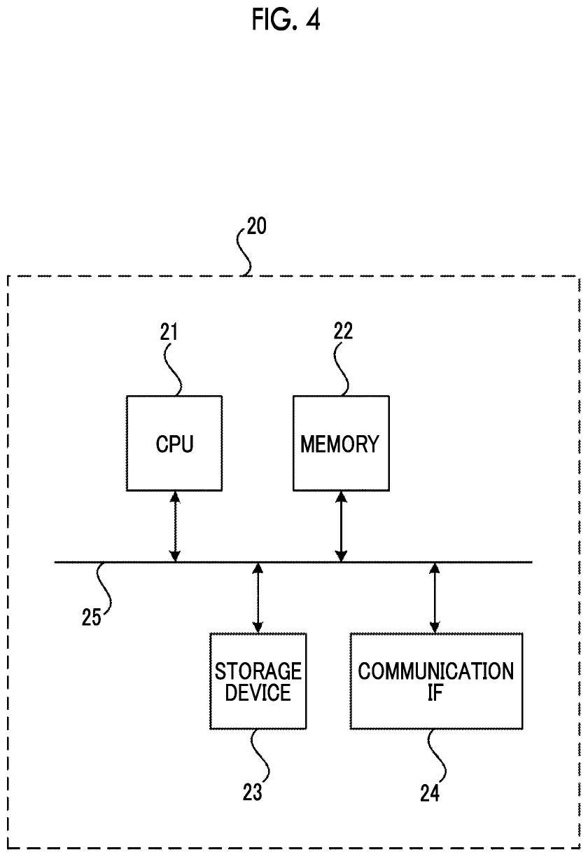

The service provision servers 20A to 20C are an example of a server that provides a service in another domain according to the exemplary embodiment of the present disclosure. FIG. 4 is a block diagram illustrating a hardware configuration of the service provision servers 20A to 20C.

All of the service provision servers 20A to 20C have a common hardware configuration and, as illustrated in FIG. 4, include a CPU 21, a memory 22, a storage device 23 such as a hard disk drive, a communication IF 24 that transmits and receives data to and from the external apparatus or the like, and a control bus 25. The CPU 21, the memory 22, the storage device 23, and the communication IF 24 are connected to each other via the control bus 25.

The CPU 21, the memory 22, the storage device 23, and the communication IF 24 are equivalent to the CPU 11, the memory 12, the storage device 13, and the communication IF 14 of the authentication server 10 and thus, will not be described.

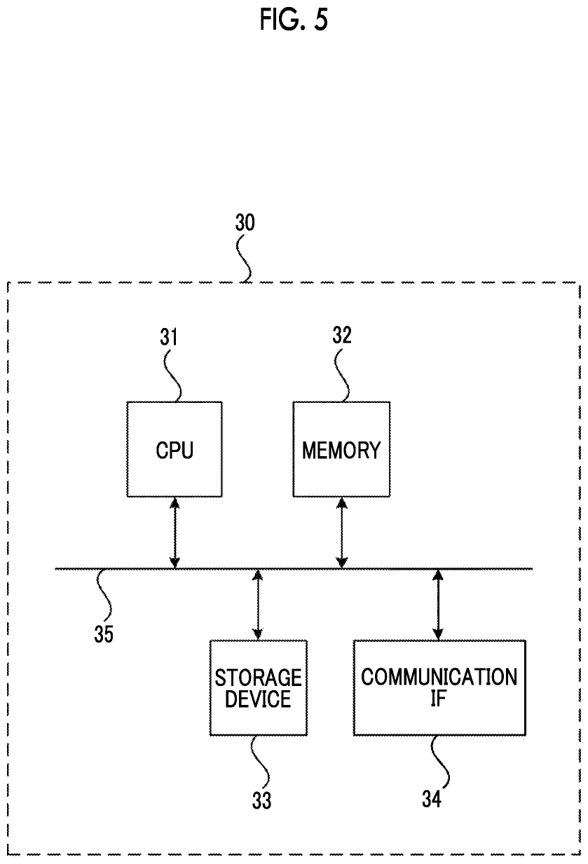

The cookie consent management server 30 is a server that manages information related to consent to use of the cookie from the user for each domain of the service provided in the authentication server 10 and the service provision servers 20A to 20C. FIG. 5 is a block diagram illustrating a hardware configuration of the cookie consent management server 30.

As illustrated in FIG. 5, the cookie consent management server 30 includes a CPU 31, a memory 32, a storage device 33 such as a hard disk drive, a communication IF 34 that transmits and receives data to and from the external apparatus or the like, and a control bus 35. The CPU 31, the memory 32, the storage device 33, and the communication IF 34 are connected to each other via the control bus 35.

The CPU 31, the memory 32, the storage device 33, and the communication IF 34 are equivalent to the CPU 11, the memory 12, the storage device 13, and the communication IF 14 of the authentication server 10 and thus, will not be described.

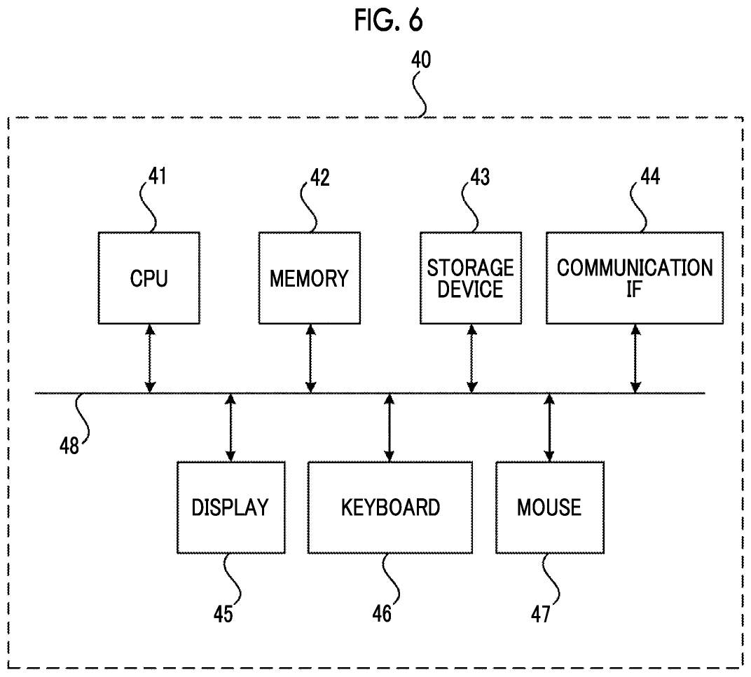

The personal computer 40 is an example of a user terminal according to the exemplary embodiment of the present disclosure. FIG. 6 is a block diagram illustrating a hardware configuration of the personal computer 40.

As illustrated in FIG. 6, the personal computer 40 includes a CPU 41, a memory 42, a storage device 43 such as a hard disk drive, a communication IF 44 that transmits and receives data to and from the external apparatus or the like, a display 45, a keyboard 46, a mouse 47, and a control bus 48. The CPU 41, the memory 42, the storage device 43, the communication IF 44, the display 45, the keyboard 46, and the mouse 47 are connected to each other via the control bus 48.

The CPU 41, the memory 42, the storage device 43, and the communication IF 44 are equivalent to the CPU 11, the memory 12, the storage device 13, and the communication IF 14 of the authentication server 10 and thus, will not be described.

In the information processing system 1, the authentication server 10 and the service provision servers 20A to 20C cooperate with each other to provide the service to the personal computer 40 that is the user terminal. The authentication server 10 provides the service using a cookie in a first domain. In addition, the service provision servers 20A to 20C provide the service using a cookie in another domain cooperating with the first domain. In a case where the service uses the cookie, the consent to the use of the cookie needs to be acquired from the user for each domain in which the service is provided. Here, “acquiring the consent to the use of the cookie for each domain” means acquiring the consent to the use of the cookie for each fully qualified domain name (FQDN) in a strict sense.

Thus, in the authentication server 10 of the present exemplary embodiment, the control unit 61 receives access to the first domain from the user terminal and, before the user terminal transitions to the other cooperating domain from the first domain, displays a screen for receiving the consent to the use of the cookie requested in accordance with the access to the first domain and the consent to the use of the cookie requested in accordance with the access to the other domain cooperating with the first domain on the user terminal.

Here, the “consent to the use of the cookie requested in accordance with the access to the first domain” means consent to the use of the cookie necessary for providing the service in at least the first domain. The consent may include, for example, consent to a cookie (so-called third-party cookie) that does not affect the provision of the service in the first domain, such as a cookie corresponding to an advertisement displayed in the first domain. Hereinafter, the “consent to the use of the cookie requested in accordance with the access to the first domain” will be referred to as the “consent to the use of the cookie in the first domain”.

Similarly, the “consent to the use of the cookie requested in accordance with the access to the other domain” means consent to the use of the cookie necessary for providing the service in at least the other domain. The consent may include, for example, consent to a cookie (so-called third-party cookie) that does not affect the provision of the service in the other domain, such as a cookie corresponding to an advertisement displayed in the other domain. Hereinafter, the “consent to the use of the cookie requested in accordance with the access to the other domain” will be referred to as the “consent to the use of the cookie in the other domain”.

In addition, a timing of displaying the screen for receiving the consent to the use of the cookie in the first domain and the consent to the use of the cookie in the other domain on the user terminal is not particularly limited as long as the timing is before the transition of the user terminal to the other domain from the first domain. For example, an aspect of requesting the consent at the same time as the access to the first domain, an aspect of requesting the consent after an elapse of a predetermined time period from the access to the first domain, or an aspect of requesting the consent in accordance with any operation performed by the user after the access to the first domain is possible.

In the present exemplary embodiment, the control unit 61 may display the screen for receiving the consent to the use of the cookie requested in accordance with the access to the first domain on the user terminal and, in receiving the consent to the use of the cookie requested in accordance with the access to the first domain, receive the consent to the use of the cookie requested in accordance with the access to the other domain cooperating with the first domain together.

At this point, the control unit 61 may receive the consent to the use of the cookie requested in accordance with the access to the first domain and the consent to the use of the cookie requested in accordance with the access to the other domain cooperating with the first domain on a common screen.

In addition, the control unit 61 may not receive an operation for an operation screen provided in the first domain, until the consent to the use of the cookie requested in accordance with the access to the first domain is acquired.

In addition, in a case where the access to the first domain is received, the control unit 61 may display a screen for receiving the consent to the use of the cookie requested in accordance with the access to the first domain.

Hereinafter, an acquisition process of the consent to the use of the cookie of each domain from the user in the information processing system 1 of the present exemplary embodiment will be described in detail.

In the information processing system 1 of the present exemplary embodiment, as an example, the first domain is a domain in which an authentication service of the user is provided, and the other domain cooperating with the first domain is a domain in which a service that is usable in a case where the authentication of the user succeeds in the first domain is provided. A content of the service provided in the other domain is not particularly limited, and any service may be provided.

That is, the information processing system 1 has a configuration referred to as so-called single sign on (SSO) in which a plurality of services provided in each domain of the service provision servers 20A to 20C are enabled by user authentication performed once in the first domain of the authentication server 10.

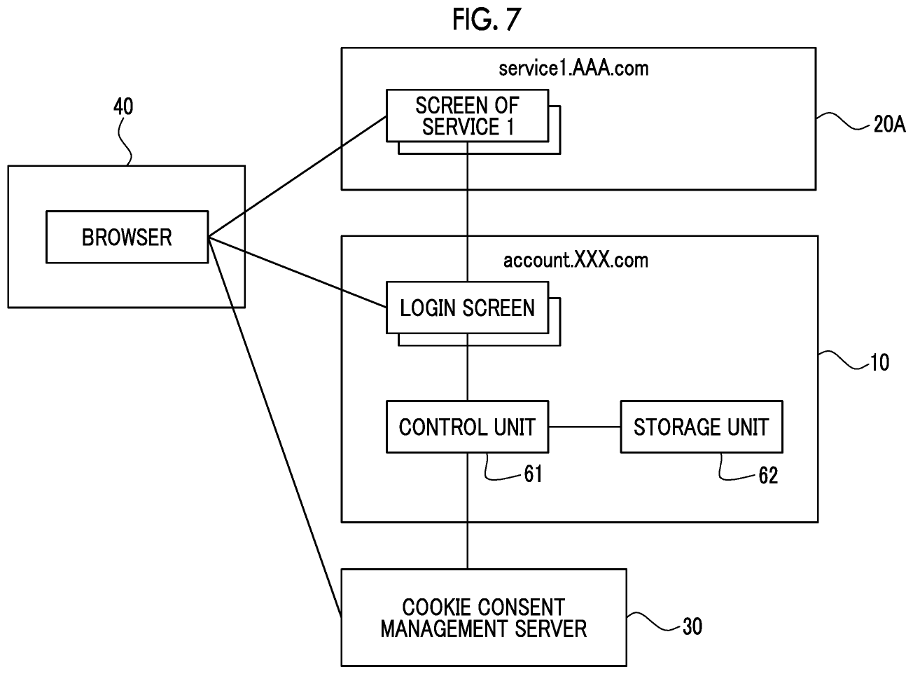

First, a case where the authentication server 10 and the service provision server 20A cooperate with each other to provide the service will be described. FIG. 7 is a diagram for describing a summary of a cooperating service in this case.

Here, the first domain provided by the authentication server 10 is assumed to be “account.XXX.com”. In addition, the other domain provided by the service provision server 20A is assumed to be “service1.AAA.com”.

As illustrated in FIG. 7, in order to use service 1 in “service1.AAA.com”, the user accesses the service provision server 20A via a browser operating in the personal computer 40 that is the user terminal.

In addition, in order for the user to use service 1, the authentication process in “account.XXX.com” is necessary. Thus, in a case where the authentication process is not performed, access to the authentication server 10 is necessary.

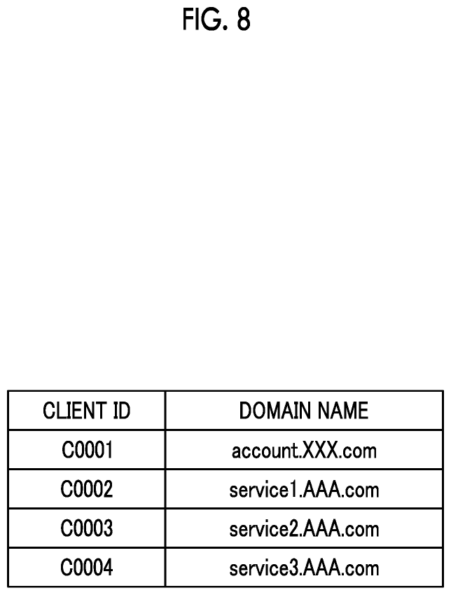

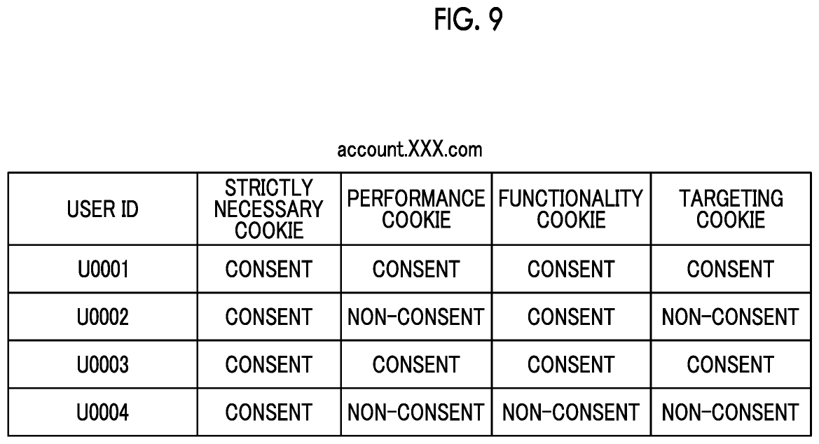

FIG. 8 is a diagram illustrating an example of a client management table managed in the cookie consent management server 30. FIG. 9 is a diagram illustrating an example of a cookie consent information management table managed in the cookie consent management server 30.

As illustrated in FIG. 8, the cookie consent management server 30 manages a client ID and a domain in association with each other. The client ID is an ID that is assigned for each client in order to specify a domain managed by the client. Even in the authentication server 10, information about the client ID corresponding to the domain of the authentication server 10 and the client ID corresponding to each domain of the service provision servers 20A to 20C cooperating with the authentication server 10 is managed.

In a case where the client ID for managing cookie consent information is acquired from the external apparatus, the cookie consent management server 30 manages the cookie consent information management table of the domain indicated by the client ID.

In the cookie consent information management table, as illustrated in FIG. 9, information related to the consent to the use of the cookie is managed for each user. More specifically, the cookie is classified into types such as a “strictly necessary cookie”, a “performance cookie”, a “functionality cookie”, and a “targeting cookie”. In the cookie consent information management table, information related to the consent to the use of the cookie is managed for each type of cookie. In FIG. 9, while the cookie consent information management table in “account.XXX.com” is illustrated as an example, the same cookie consent information management table is provided for each domain.

The “strictly necessary cookie” is a cookie necessary for normal functioning of a website of a target domain. The “performance cookie” is a cookie for enabling counting of the number of visitors and communication traffic sources with respect to the website. The “functionality cookie” is a cookie for enabling enhancement and personalization of a function of the website. The “targeting cookie” is a cookie for enabling creation of a profile based on a usage situation of the user on the website and display of an advertisement of high interest to the user even on other websites.

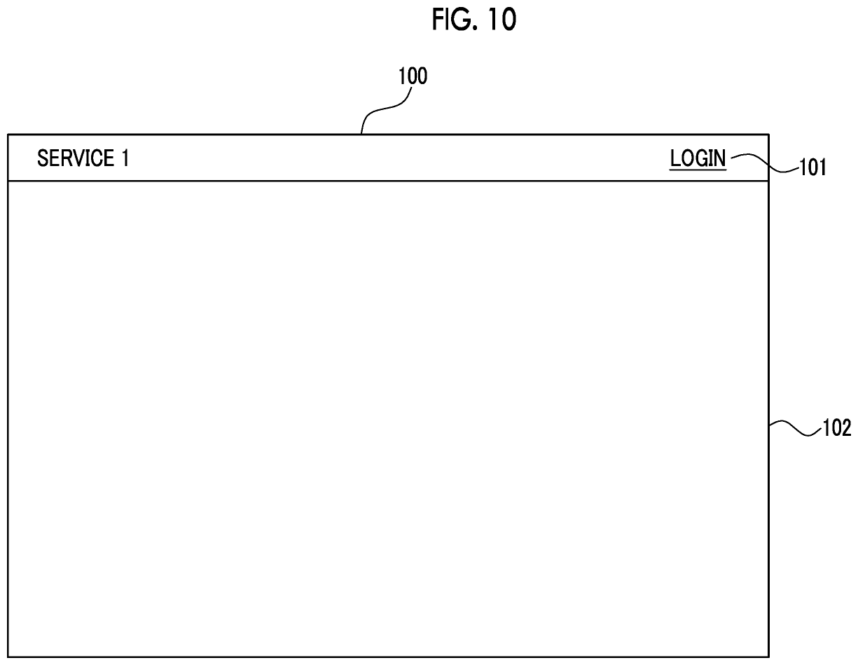

FIG. 10 is a display example of a screen 100 of a website of service 1. In a case where access from the browser operating in the personal computer 40 is received by an operation of the user, the service provision server 20A displays the screen 100 of the website of service 1 provided in “service1.AAA.com” on the display 45.

The screen 100 of service 1 includes a “login” button 101 and a service provision unit 102. The “login” button 101 is linked to a website for login provided by “account.XXX.com” of the authentication server 10. In a case where the user provides an input on the “login” button 101, the service provision server 20A causes the browser to access the authentication server 10 using a redirect function.

The redirect function means a function of automatically transferring, in a case where a uniform resource locator (URL) of a website or a page is changed, the user who has accessed the URL before change to the new URL.

At this point, the service provision server 20A notifies the authentication server 10 of the client ID indicating “service1.AAA.com”.

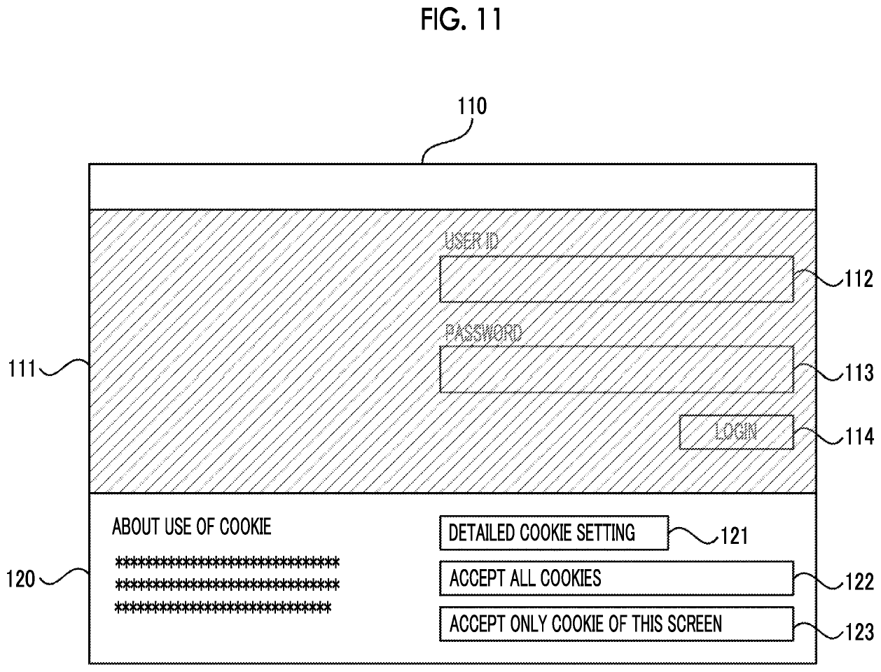

FIG. 11 is a display example of a screen 110 of the website for login. In a case where access to “account.XXX.com” is received from the browser, the control unit 61 of the authentication server 10 displays the screen 110 of the website for login provided in “account.XXX.com” on the display 45. At this point, the control unit 61 displays a cookie consent banner 120 for receiving the consent to the use of the cookie requested in accordance with the access to “account.XXX.com” together in the screen 110.

In addition to the cookie consent banner 120, as illustrated in FIG. 11, a service provision unit 111 for providing the authentication service of the user is displayed on the login screen 110. The service provision unit 111 includes an input box 112 for inputting a user ID, an input box 113 for inputting a password, and a “login” button 114 for executing login.

However, in “account.XXX.com” in the authentication server 10, since the authentication service of the user is provided using the cookie, the consent to the use of the cookie needs to be acquired from the user in order to perform the authentication process of the user in the authentication server 10.

Thus, the control unit 61 does not receive an operation for the service provision unit 111 until the consent to the use of the cookie in “account.XXX.com” is acquired from the user. In addition, in order to clearly show the user that an operation for the service provision unit 111 cannot be performed, the control unit 61 displays the service provision unit 111 in a grayed-out manner on the login screen 110.

In addition, the control unit 61 identifies cooperation between “service1.AAA.com” and “account.XXX.com” based on the client ID indicating “service1.AAA.com” acquired from the service provision server 20A.

The control unit 61 enables acquisition of the consent to the use of the cookie in “account.XXX.com” and also acquisition of the consent to the use of the cookie in “service1.AAA.com” on the cookie consent banner 120 displayed on the screen 110 for login.

The cookie consent banner 120 includes a “detailed cookie setting” button 121, an “accept all cookies” button 122, and an “accept only cookie of this screen” button 123.

The “detailed cookie setting” button 121 is a button for individually setting consent or non-consent for each type of cookie for the cookie used in “account.XXX.com” and “service1.AAA.com”.

In a case where an input is provided on the “detailed cookie setting” button 121, the control unit 61 displays a screen for receiving the consent to the use of the cookie in “account.XXX.com” and the consent to the use of the cookie in “service1.AAA.com” together.

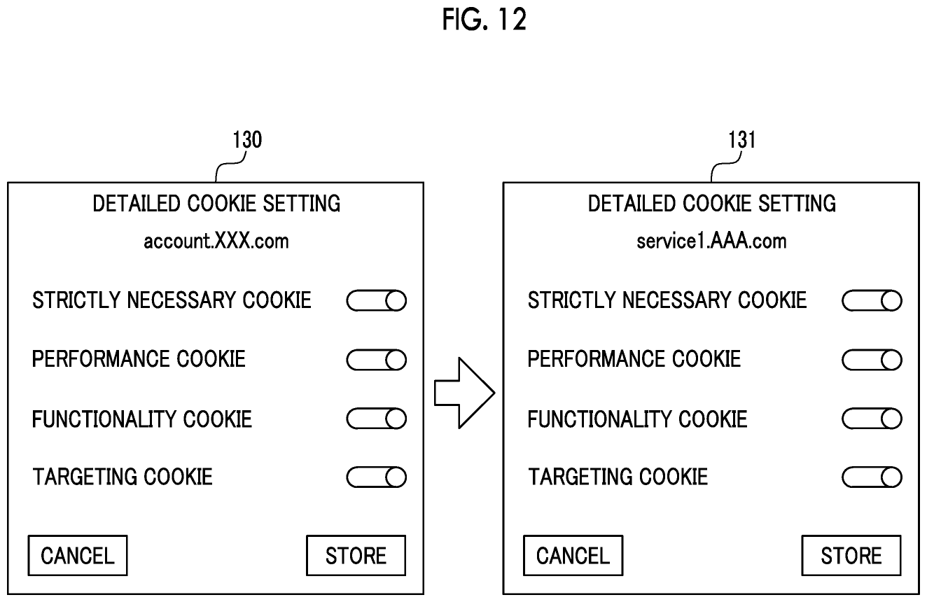

For the display of the screen at this point, as illustrated in FIG. 12, a screen 130 for setting for “account.XXX.com” and a screen 131 for setting for “service1.AAA.com” may be individually displayed.

An input for setting consent or non-consent can be provided for each type of the “strictly necessary cookie”, the “performance cookie”, the “functionality cookie”, and the “targeting cookie” in “account.XXX.com” on the screen 130.

In addition, an input for setting consent or non-consent can be provided for each type of the “strictly necessary cookie”, the “performance cookie”, the “functionality cookie”, and the “targeting cookie” in “service1.AAA.com” on the screen 131.

Specifically, in a case where an input is provided on the “detailed cookie setting” button 121, the screen 130 for setting for “account.XXX.com” may be first displayed, and the screen 131 for setting for “service1.AAA.com” may be displayed after the input on the screen 130 is completed.

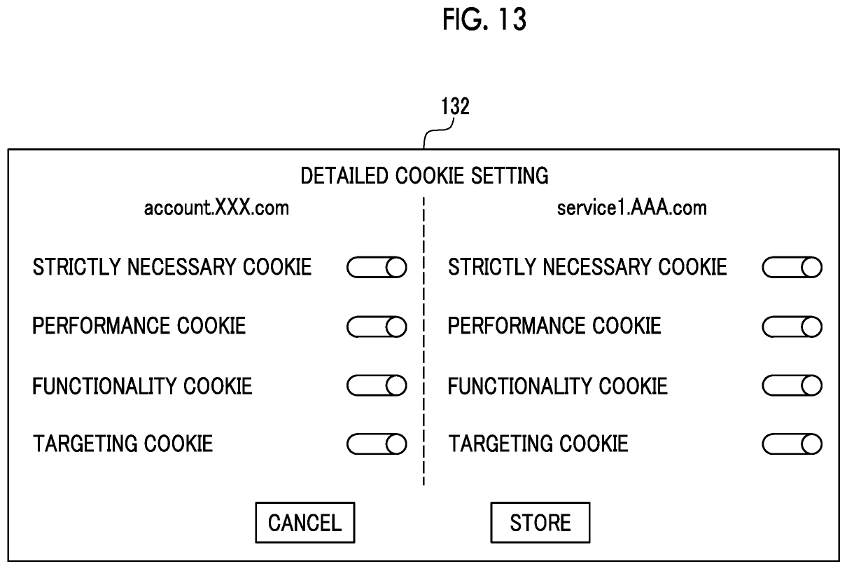

In addition, as illustrated in FIG. 13, a screen 132 for setting for “account.XXX.com” and “service1.AAA.com” on a common screen may be displayed.

An input for setting consent or non-consent can be provided for each type of the “strictly necessary cookie”, the “performance cookie”, the “functionality cookie”, and the “targeting cookie” in each of “account.XXX.com” and “service1.AAA.com” on the screen 132.

The “accept all cookies” button 122 is a button for setting consent to use of all cookies used in “account.XXX.com” and “service1.AAA.com”.

The “accept only cookie of this screen” button 123 is a button for setting consent to use of all cookies used in “account.XXX.com”.

The control unit 61 notifies the cookie consent management server 30 of information related to cookie consent input from the user on the cookie consent banner 120. Here, an example of a case where the user provides an input on the “accept all cookies” button 122 on the cookie consent banner 120 will be described.

The cookie consent management server 30 updates the cookie consent information management table based on information acquired from the browser. In the present example, a content of the cookie consent information management table is updated such that the consent to the use of all cookies used in “account.XXX.com” and “service1.AAA.com” is provided.

In addition, in a case where consent to use of at least the “strictly necessary cookie” is acquired from the user with respect to the consent to the use of the cookie in “account.XXX.com”, the cookie consent management server 30 transmits a notification indicating cancelation of operation prohibition in the domain to the authentication server 10.

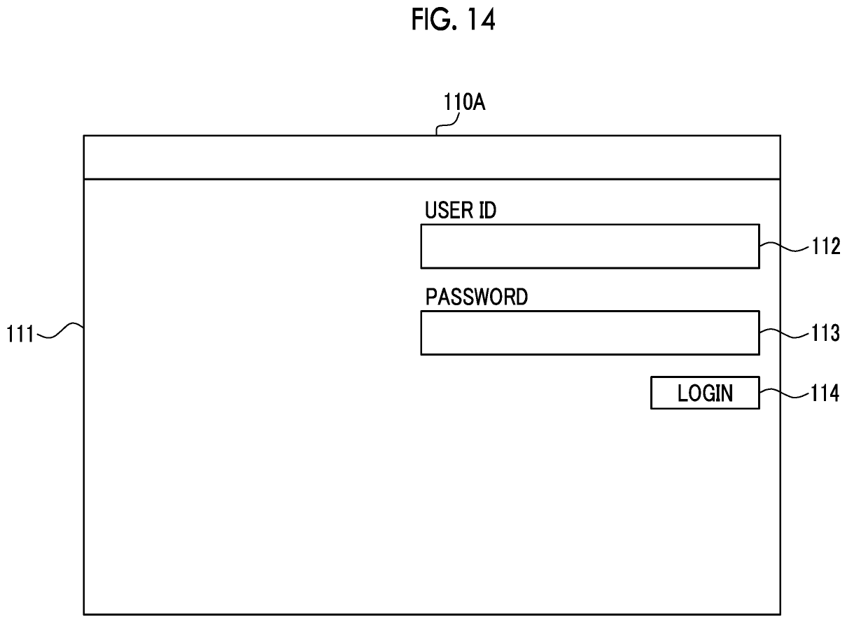

The control unit 61 receives the notification indicating the cancelation of the operation prohibition from the cookie consent management server 30 and receives the operation for the service provision unit 111 on a login screen 110A as illustrated in FIG. 14. In addition, in order to clearly show the user that the operation for the service provision unit 111 can be performed, the control unit 61 cancels the grayed-out display of the service provision unit 111 and normally displays the service provision unit 111 on the login screen 110A. In addition, the control unit 61 does not display the cookie consent banner 120 on the login screen 110A after the cancelation of the operation prohibition.

In a case where the user provides an input on the “login” button 114 by inputting the user ID and the password in the service provision unit 111, the control unit 61 executes the authentication process for the user.

In a case where the authentication process for the user succeeds, the control unit 61 causes the browser to access the service provision server 20A using the redirect function.

In a case where the access from the browser is received, the service provision server 20A displays the screen 100 of the website of service 1 provided in “service1.AAA.com” on the display 45.

At this point, the service provision server 20A asks the cookie consent management server 30 to check whether or not the user consents to the use of the cookie in “service1.AAA.com”.

In a case where the user has already consented to the use of the cookie in “service1.AAA.com”, the service provision server 20A provides service 1 without checking with the user with respect to the use of the cookie on the website in “service1.AAA.com”.

Furthermore, in the present exemplary embodiment, in a case where a plurality of the other domains cooperating with the first domain are present, the control unit 61 may, before the user terminal transitions to any of the other domains from the first domain, display a screen for receiving the consent to the use of the cookie requested in accordance with the access to the first domain and the consent to the use of the cookie requested in accordance with access to the plurality of other domains from the user operating the user terminal on the user terminal.

At this point, the control unit 61 may refer to information in which another different domain related to each of the other domains cooperating with the first domain is defined, and, before a transition is made to one of the other domains from the first domain, display a screen for receiving the consent to the use of the cookie requested in accordance with the access to the first domain, the consent to the use of the cookie requested in accordance with the access to the other domain to which the transition is made from the first domain, and the consent to the use of the cookie requested in accordance with access to the other different domain related to the other domain on the user terminal.

In the present exemplary embodiment, three domains of “service1.AAA.com” provided by the service provision server 20A, “service2.AAA.com” provided by the service provision server 20B, and “service3.AAA.com” provided by the service provision server 20C are assumed to be present as the other domains cooperating with the first domain.

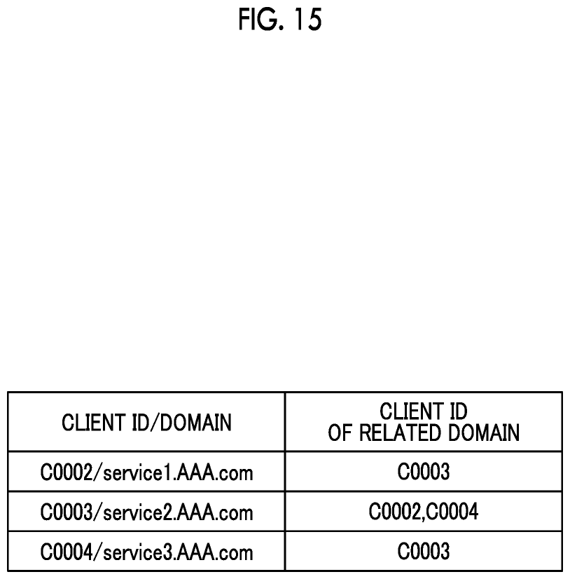

In this case, as illustrated in FIG. 15, a table in which information related to a relationship among the domains is managed is prepared in advance and is stored in the storage unit 62. In a case where access via any of the domains “service1.AAA.com”, “service2.AAA.com”, and “service3.AAA.com” is received, the control unit 61 refers to the table and extracts a different domain related to the accessed domain.

For example, in a case where access via “service1.AAA.com” is received, the control unit 61 refers to the table and extracts “service2.AAA.com” as the related different domain.

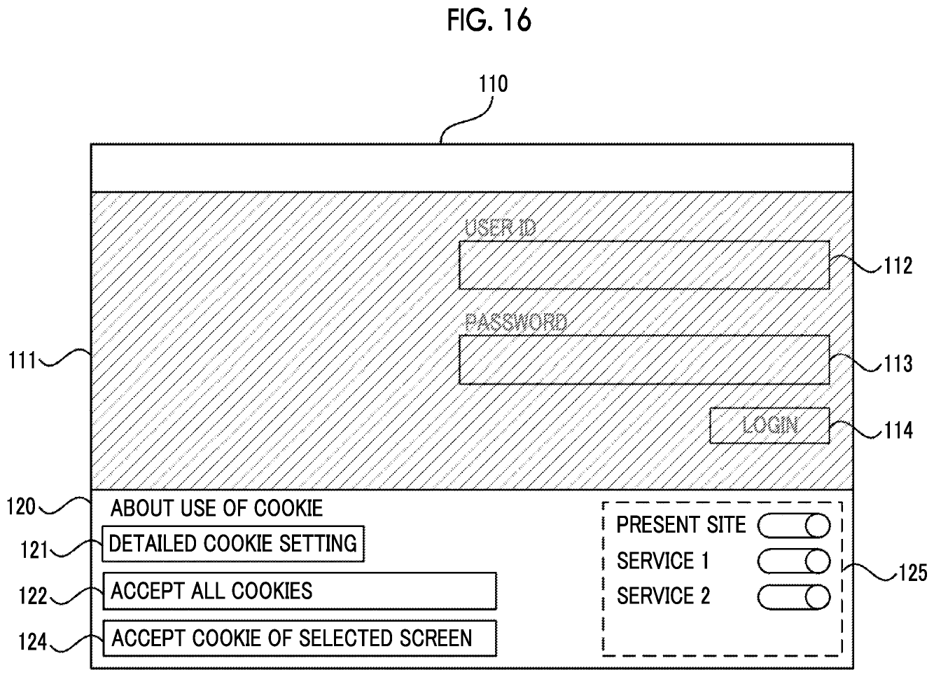

As illustrated in FIG. 16, the control unit 61 displays the cookie consent banner 120 for acquiring the cookie consent in the three domains on the login screen 110 based on the client ID indicating “account.XXX.com”, the client ID indicating “service1.AAA.com”, and the client ID indicating “service2.AAA.com”.

The cookie consent banner 120 includes the “detailed cookie setting” button 121, the “accept all cookies” button 122, an “accept cookie of selected screen” button 124, and a cookie consent screen selection unit 125.

The “accept cookie of selected screen” button 124 is a button for setting consent to use of all cookies used in the domain selected in the cookie consent screen selection unit 125.

In the cookie consent screen selection unit 125, items of “present site” indicating “account.XXX.com”, “service 1” indicating “service1.AAA.com”, and “service 2” indicating service2.AAA.com” are displayed based on the client ID acquired from the authentication server 10. Consent or non-consent can be set for each item in the cookie consent screen selection unit 125.

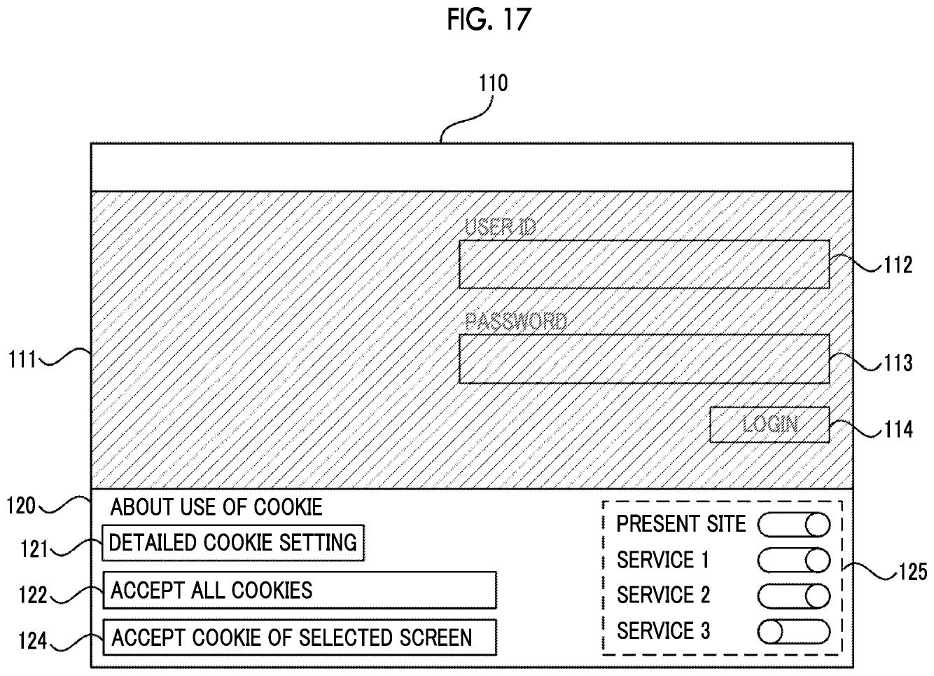

As illustrated in FIG. 17, all domains cooperating with the first domain may be displayed. In addition, setting for the domain corresponding to the client ID acquired from the authentication server 10 may be displayed in a consent state as an initial state, and setting for the domains corresponding to the client IDs not acquired from the authentication server 10 may be displayed in a non-consent state as an initial state.

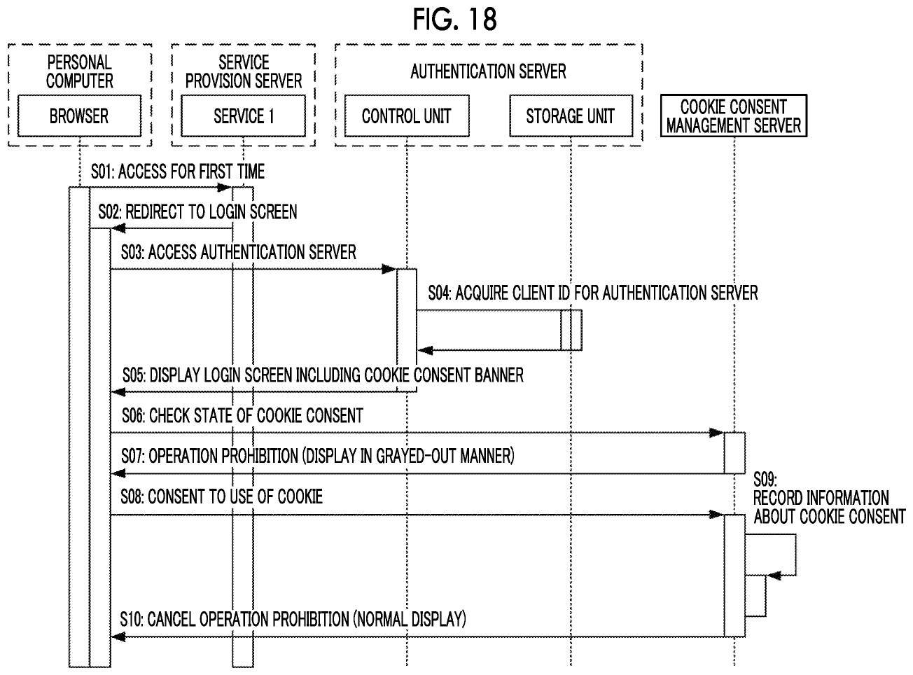

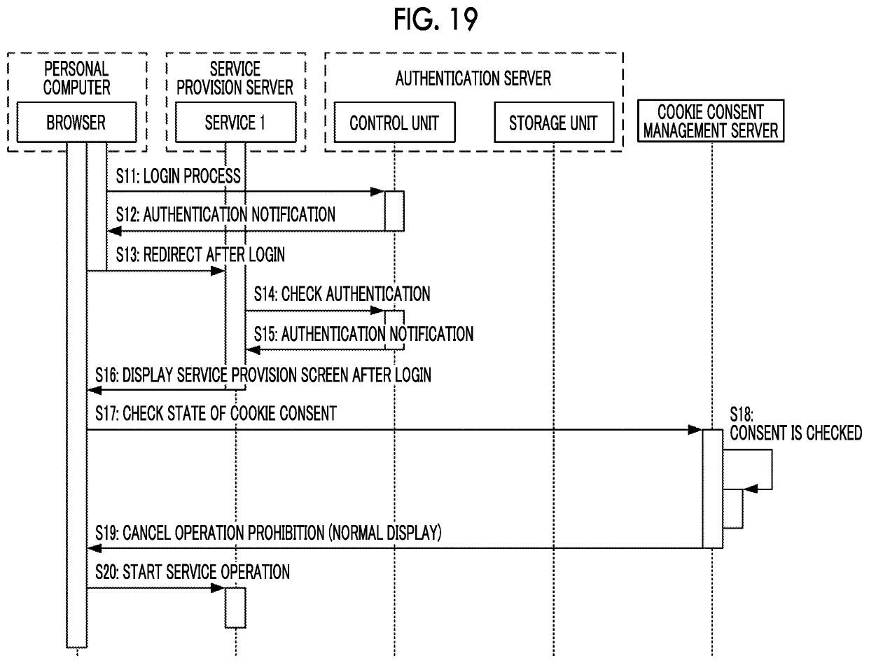

Next, the acquisition process of the consent to the use of the cookie of each domain from the user in the information processing system 1 of the present exemplary embodiment will be described with reference to the flowcharts in FIG. 18 and FIG. 19. The flowcharts in FIG. 18 and FIG. 19 illustrate a series of flowcharts divided into a first half and a second half.

In step S01, the browser operating in the personal computer 40 that is the user terminal accesses the service provision server 20A providing “service 1” in “service1.AAA.com” for the first time based on an instruction input of the user.

Next, in step S02, the service provision server 20A displays the screen of the website of service 1 provided in “service1.AAA.com” on the browser. In addition, since the access from the browser is performed for the first time, the service provision server 20A transmits an instruction to redirect to the authentication server 10 to the browser in order to perform the user authentication. At this point, the service provision server 20A notifies the browser of the client ID indicating “service1.AAA.com”.

Next, in step S03, the browser accesses the authentication server 10 that provides the authentication service in “account.XXX.com”. At this point, the browser notifies the authentication server 10 of the client ID indicating “service1.AAA.com”.

Next, in step S04, the control unit 61 of the authentication server 10 refers to the storage unit 62 and acquires the client ID indicating “account.XXX.com”.

Next, in step S05, the control unit 61 displays a login screen of a website of the authentication service provided in “account.XXX.com” on the browser. At this point, the control unit 61 displays a cookie consent banner in the login screen. In the cookie consent banner displayed here, the consent to the use of the cookie in “account.XXX.com” and “service1.AAA.com” can be acquired from the user. In addition, the control unit 61 notifies the browser of the client ID indicating “account.XXX.com”.

Next, in step S06, the browser accesses the cookie consent management server 30 and checks whether or not the user consents to the use of the cookie in “account.XXX.com” based on the client ID indicating “account.XXX.com”.

Next, in step S07, since the consent to the use of the cookie in “account.XXX.com” is not obtained from the user, the cookie consent management server 30 notifies the browser of the operation prohibition in “account.XXX.com”. Accordingly, an operation input unit of the login screen is displayed in a grayed-out manner.

Next, in step S08, the browser notifies the cookie consent management server 30 of the consent to the use of the cookie in “account.XXX.com” and “service1.AAA.com” based on an operation of the user on the cookie consent banner.

Next, in step S09, the cookie consent management server 30 records information about the consent of the user to the use of the cookie in “account.XXX.com” and “service1.AAA.com” in the cookie consent information management table.

Next, in step S10, since the consent to the use of the cookie in “account.XXX.com” is obtained from the user, the cookie consent management server 30 notifies the browser of the cancelation of the operation prohibition in “account.XXX.com”. Accordingly, the operation input unit of the login screen is normally displayed.

Next, in step S11, the browser performs a login process by transmitting the user ID and the password input from the user on the login screen to the authentication server 10.

Next, in step S12, the authentication server 10 performs the authentication process based on the user ID and the password acquired from the browser and, in a case where the authentication succeeds, transmits an authentication notification to the browser.

Next, in step S13, the browser accesses the service provision server 20A by redirection after login.

Next, in step S14, the service provision server 20A checks whether or not the user for which the access is received is authenticated.

Next, in step S15, since the user for which the access is received is authenticated in step S12, the authentication server 10 transmits the authentication notification to the browser.

Next, in step S16, the service provision server 20A displays a service provision screen after login on the browser.

Next, in step S17, the browser accesses the cookie consent management server 30 and checks whether or not the user consents to the use of the cookie in “service1.AAA.com”.

Next, in step S18, the cookie consent management server 30 refers to the cookie consent information management table and checks whether or not the user consents to the use of the cookie in “service1.AAA.com”.

Next, in step S19, since the consent to the use of the cookie in “service1.AAA.com” is obtained from the user, the cookie consent management server 30 notifies the browser of the cancelation of the operation prohibition in “service1.AAA.com”. Accordingly, an operation input unit of the service screen is normally displayed.

Finally, in step S20, the browser starts a normal operation in “service1.AAA.com”.

### Modification Example

While the information processing system 1 of the exemplary embodiment of the present invention is described above, the present invention is not limited to the exemplary embodiment and can be appropriately changed.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

### Supplementary Note

Supplementary notes about the exemplary embodiment of the present disclosure are provided below.

(((1)))

An information processing apparatus comprising:

a processor configured to:
receive access to a first domain from a user terminal; and
before the user terminal transitions to another cooperating domain from the first domain, display a screen for receiving consent to use of a cookie requested in accordance with the access to the first domain and consent to use of a cookie requested in accordance with the access to the other domain cooperating with the first domain on the user terminal.

(((2)))

The information processing apparatus according to (((1))), wherein the processor is configured to:

display a screen for receiving the consent to the use of the cookie requested in accordance with the access to the first domain on the user terminal and, in receiving the consent to the use of the cookie requested in accordance with the access to the first domain, receive the consent to the use of the cookie requested in accordance with the access to the other domain cooperating with the first domain together.

(((3)))

The information processing apparatus according to (((2))), wherein the processor is configured to:

receive the consent to the use of the cookie requested in accordance with the access to the first domain and the consent to the use of the cookie requested in accordance with the access to the other domain cooperating with the first domain on a common screen.

(((4)))

The information processing apparatus according to any one of (((1))) to (((3))), wherein the processor is configured to:

not receive an operation for an operation screen provided in the first domain, until the consent to the use of the cookie requested in accordance with the access to the first domain is acquired.

The information processing apparatus according to any one of (((1))) to (((4))), wherein the processor is configured to:

in a case where the access to the first domain is received, display a screen for receiving the consent to the use of the cookie requested in accordance with the access to the first domain.

(((6)))

The information processing apparatus according to any one of (((1))) to (((5))), wherein the processor is configured to:

in a case where a plurality of the other domains cooperating with the first domain are present,

before the user terminal transitions to any of the other domains from the first domain, display a screen for receiving the consent to the use of the cookie requested in accordance with the access to the first domain and consent to use of a cookie requested in accordance with access to the plurality of other domains from a user operating the user terminal on the user terminal.

(((7)))

The information processing apparatus according to (((6))), wherein the processor is configured to:

refer to information in which another different domain related to each of the other domains cooperating with the first domain is defined; and

before a transition is made to one of the other domains from the first domain, display a screen for receiving the consent to the use of the cookie requested in accordance with the access to the first domain, consent to use of a cookie requested in accordance with access to the other domain to which the transition is made from the first domain, and consent to use of a cookie requested in accordance with access to the other different domain related to the other domain on the user terminal.

(((8)))

The information processing apparatus according to any one of (((1))) to (((7))),

wherein the first domain is a domain in which a service for authentication of a user is provided, and

the other domain cooperating with the first domain is a domain in which a service that is enabled in a case where the authentication of the user succeeds in the first domain is provided.

(((9)))

A program causing a computer to execute:

a step of receiving access to a first domain from a user terminal; and

a step of displaying, before the user terminal transitions to another cooperating domain from the first domain, a screen for receiving consent to use of a cookie requested in accordance with the access to the first domain and consent to use of a cookie requested in accordance with the access to the other domain cooperating with the first domain on the user terminal.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing apparatus comprising:
a processor configured to:
receive access to a first domain from a user terminal; and
before the user terminal transitions to another cooperating domain from the first domain, display a screen for receiving consent to use of a cookie requested in accordance with the access to the first domain and consent to use of a cookie requested in accordance with the access to the other domain cooperating with the first domain on the user terminal.

2. The information processing apparatus according to claim 1, wherein the processor is configured to:
display a screen for receiving the consent to the use of the cookie requested in accordance with the access to the first domain on the user terminal and, in receiving the consent to the use of the cookie requested in accordance with the access to the first domain, receive the consent to the use of the cookie requested in accordance with the access to the other domain cooperating with the first domain together.

3. The information processing apparatus according to claim 2, wherein the processor is configured to:
receive the consent to the use of the cookie requested in accordance with the access to the first domain and the consent to the use of the cookie requested in accordance with the access to the other domain cooperating with the first domain on a common screen.

4. The information processing apparatus according to claim 1, wherein the processor is configured to:
not receive an operation for an operation screen provided in the first domain, until the consent to the use of the cookie requested in accordance with the access to the first domain is acquired.

5. The information processing apparatus according to claim 1, wherein the processor is configured to:
in a case where the access to the first domain is received, display a screen for receiving the consent to the use of the cookie requested in accordance with the access to the first domain.

6. The information processing apparatus according to claim 1, wherein the processor is configured to:
in a case where a plurality of the other domains cooperating with the first domain are present,
before the user terminal transitions to any of the other domains from the first domain, display a screen for receiving the consent to the use of the cookie requested in accordance with the access to the first domain and consent to use of a cookie requested in accordance with access to the plurality of other domains from a user operating the user terminal on the user terminal.

7. The information processing apparatus according to claim 6, wherein the processor is configured to:
refer to information in which another different domain related to each of the other domains cooperating with the first domain is defined; and
before a transition is made to one of the other domains from the first domain, display a screen for receiving the consent to the use of the cookie requested in accordance with the access to the first domain, consent to use of a cookie requested in accordance with access to the other domain to which the transition is made from the first domain, and consent to use of a cookie requested in accordance with access to the other different domain related to the other domain on the user terminal.

8. The information processing apparatus according to claim 1,
wherein the first domain is a domain in which a service for authentication of a user is provided, and
the other domain cooperating with the first domain is a domain in which a service that is enabled in a case where the authentication of the user succeeds in the first domain is provided.

9. A non-transitory computer readable medium storing a program causing a computer to execute a process comprising:
receiving access to a first domain from a user terminal; and
displaying, before the user terminal transitions to another cooperating domain from the first domain, a screen for receiving consent to use of a cookie requested in accordance with the access to the first domain and consent to use of a cookie requested in accordance with the access to the other domain cooperating with the first domain on the user terminal.

10. An information processing method comprising:
receiving access to a first domain from a user terminal; and
displaying, before the user terminal transitions to another cooperating domain from the first domain, a screen for receiving consent to use of a cookie requested in accordance with the access to the first domain and consent to use of a cookie requested in accordance with the access to the other domain cooperating with the first domain on the user terminal.
